(19) United States
(12) Patent Application Publication
(10) Pub. No.: US 2019/0182252 A1
(43) Pub. Date: Jun. 13, 2019

(54) WEB BASED BACKGROUND CHECK SYSTEM AND METHOD FOR ACCESS AND VERIFICATION OF CREDENTIALS

(71) Applicant: Tirupati Raju Dandu, Mumbai (IN)

(72) Inventor: Tirupati Raju Dandu, Mumbai (IN)

(21) Appl. No.: 16/307,890

(22) PCT Filed: Sep. 3, 2016
(86) PCT No.: PCT/IN2016/050294

§ 371 Date: Dec. 6, 2018

(30) Foreign Application Priority Data
Jul. 22, 2016 (IN) 201641025199

(51) Int. Cl. H04L 29/06; G06Q 50/26

(52) U.S. Cl. CPC H04L 63/0884; G06Q 50/265

(57) ABSTRACT

A web based background check system for verification of credentials includes a partner organization verification request raising component, a central hub and a partner organization verification component. The verification request raising component is internally integrated with at least one partner organization to raise a profile information verification request. The central hub includes a controller component, a core service component, and a central hub database. The controller component communicates with a user interface. The core service component communicates with the partner organization verification request raising component through web service calls that are accepted by the central hub. The partner organization verification component is integrated with the partner organization internal system to receive the web service calls raised by the central hub. The partner organization verification component selectively runs on a server of the partner organization or a cloud based system to validate individual experience verification request from the central hub.

### CROSS-REFERENCE TO RELATED APPLICATION

The present application is the US national phase of International Application No. PCT/IN2016/050294, filed Sep. 3, 2016, which is based on and claims priority to Indian Application No. 201641025199, filed Jul. 22, 2016, the disclosures of which are incorporated herein by reference in their entireties.

### FIELD OF THE INVENTION

The present invention relates to profile verification systems and more particularly to a web based credential verification method and system wherein details of various organizations can be accessed by a web based aggregating central system.

### BACKGROUND OF THE INVENTION

Various organizations in various sectors, such as educational institutions, companies, governmental agencies, banking, insurance and the like, commonly face dire need for profile verification as the received information is often misleading or fallacious. Moreover, most of the organizations fail to perform thorough background checks of the received credentials as it is a time consuming process and additionally requires human resource to be devoted for the same. Particularly, the need of profile verification is highlighted in recruitment process for verification of various credentials of the candidate such as name, identity, address, education, qualification, experience, criminal history and the like.

Currently known profile verification systems in the art are completely manual as the person verifying the credentials has to physically check all the data manually based on the received request. Also, the currently known profile verification systems in the art involve considerable time delays as the verifying person has to reach out to multiple individual entities such as companies, universities and government departments and the like, for collection of data of the person whose profile is being verified.

There are few efforts seen in the art towards providing automated systems for profile verification. For example, United States Patent document no. US20130282605A1 describes a system and method for creating a user profile and controlling access via a set of user controlled settings. However, such system is related to user profiles sharing and providing access to others users based on permission provided by the owner. Another example, United States Patent document no. US2006287970A1 discloses a system for automatically screening resumes and/or job/admission applications for false information as well as for specific factors that make a particular candidate non-suitable for a particular job or school. However, verification in said system is based on sending verification request through email and requesting response to be in a predefined parseable format.

Accordingly, there is a need of a web based background check system for access and verification of credentials that overcomes all the drawbacks of the prior art.

### SUMMARY OF THE INVENTION

The present invention provides a web based background check system for access and verification of credentials that comprises a central hub that connects to all the partner organizations. The central hub includes a core service component, a web service layer and a web service client layer. The core service component stores and provides information that is accessible through a web service layer and a user interface. The web service layer is configured to accept verification requests. The web service client layer is configured to raise individual requests to the partner organizations. The user interface acts as a part of the central hub and is available over the internet for organizations to access the system directly rather than use a web service to raise a request. The system of the present invention includes individual partner organizations. The major components are part of the integrated system with the partner organization such that at least one component provides access to the central server to verify information based on a request and at least one component is able to raise a verification request to the central server.

### BRIEF DESCRIPTION OF THE DRAWINGS

FIG. 1 is an integrated system architecture of a web based background check system for access and verification of credentials in accordance with the present invention;

FIG. 2 is a logical work flow of a core service component and a central hub of the web based background check system of FIG. 1;

FIG. 3 is an operational flowchart of a core service component of the web based background check system of FIG. 1; and

FIG. 4 is a partner organization architecture of the web based background check system of FIG. 1.

### DETAILED DESCRIPTION OF THE INVENTION

Although specific terms are used in the following description for sake of clarity, these terms are intended to refer only to particular structure of the invention selected for illustration in the drawings, and are not intended to define or limit the scope of the invention.

The invention described herein is explained using specific exemplary details for better understanding. However, the invention disclosed can be worked on by a person skilled in the art without the use of these specific details.

References in the specification to “one embodiment” or “ an embodiment” means that a particular feature, structure, characteristic, or function described in connection with the embodiment is included in at least one embodiment of the invention. The appearances of the phrase “in one embodiment” in various places in the specification are not necessarily all referring to the same embodiment.

References in the specification to “preferred embodiment” means that a particular feature, structure, characteristic, or function described in detail thereby omitting known constructions and functions for clear description of the present invention.

Accordingly, the present invention provides a web based background check system for access and verification of credentials wherein all the details which are captured by various companies, institutions and government agencies are accessed by an aggregating central system through web services.

In the context of the present invention, the term “partner organizations” is used to represent organizations including but not limited to banks, software companies, pharma companies, construction companies, automobile industries, institutions into education including but not limited to universities, colleges, central and state education boards, training institutions, government departments for address, PAN, criminal, police and court (judicial) verification and Tax verifications in western countries that are available at the state or central level of respective countries.

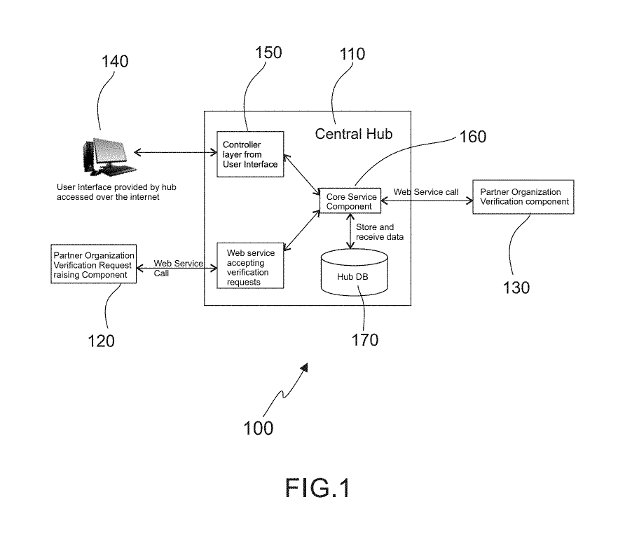

Referring to FIG. 1, a web based background check system 100 adapted for access and verification of credentials is shown that includes a central hub 110, a partner organization verification request raising component 120, a partner organization verification component 130 and a user interface 140. In an embodiment, the partner organization verification request raising component and the partner organization verification component are configured on a same computing device of the partner organization. In another embodiment, the partner organization verification request raising component and the partner organization verification component are configured on different computing devices of the partner organization. In one more embodiment, the partner organization verification request raising component and the partner organization verification component have software that run on a same server of the partner organization. In one another embodiment, the partner organization verification request raising component and the partner organization verification component have software that run on different servers of the partner organization.

The central hub 110 includes a controller component 150, a core service component 160 and a central hub database 170. The core service component 160 is configured to communicate with the user interface 140 through the controller component 150 thereby facilitating a user to access the central hub 110. The core service component 160 is configured to communicate with partner organization verification request raising component 120 and the partner organization verification component 130 through web service calls such that the central hub 110 accepts the web service calls and further raises web service calls to the partner organization verification component 130 thereby storing and receiving data in the hub database 170.

The central hub 110 is configured to receive an input in form of a request selectively from the user interface 140 or a web service request from the partner organizations with details such as unique ID, employment details, education details and the like. The central hub 110 is configured to split an individual experience and process the same by checking for discrepancies in experience and organization attributes. The central hub 110 raises web service requests to the partner organizations mentioned in the individual experience. The central hub 110 is configured to collate a response from all partners and provide the same as an output. The partner organization verification request raising component 120 is configured to raise a request to the central hub 110 that becomes an input to the central hub 110. The partner organization verification request raising component 120 is configured to receive a response which is an output from the central hub 110. The partner organization verification component 130 receives a request from the central hub 110 as an input in form of an individual experience such that verification of the input is performed by a plurality of internal systems. The partner organization verification component 130 provides an output which is a response built on the verification.

In an embodiment of the present invention, the central hub 110 includes a person module, a date module, an organization verification module and an authentication module. The person module facilitates addition of a person into the central hub 110 in order to individually identify a person and provide a unique ID to the person for easy identification when sharing information across the system 100.

In an embodiment, the service component 160 includes a date module to add/ update/verify the joining and exit dates provided by the partner organization to the central hub 110 in the profile information verification requests raised against the unique ID of the individual for the partner organization. The organization verification module provides the organization related attributes of the organizations mentioned in the profile information verification request for validating the legality and authenticity of the organization. The authentication module is adapted to authenticate users who add/or update data and request verification.

In the context of the present invention, the core service component 160 segregates the profile information verification request to the date module, the organization verification module, and the partner organization verification component. In addition, the core service component aggregates the multiple responses coming from the date module, organization verification module, and partner organization verification component and sends the same to the user interface and/or the web service.

The core service component 160 interacts with the central hub database 170 which stores information pertaining to attributes to individually identify a person through identifications issued by Governments of countries. In addition, the central hub database 170 stores attribute to centrally maintain the list of organizations along with certain attributes to ascertain if the organizations are genuine. In addition, the central hub database 170 stores information pertaining to web Service URLs and authentication for all partner organizations. In addition, the central hub database 170 stores information pertaining to user allied to the central hub 110 as well as the organizational users who would be allowed to access system 100. The central hub database 170 also maintains critical information like joining date and exit date of each company experience within the hub database for verification. The central hub data base 170 also maintains attributes of an organization for its validity such as registration with government, tax payments, physical verification and the like which facilitates the requesting entity to make a decision on the acceptance of the company as valid.

In the context of the present invention, the central hub 110 includes a web service client layer that is integrated in the Core Service Component 160. If the organization is found to be registered, the web service client retrieves the web service URL and the authentication information for individual partner organization identified in the list of verifiable experience components. It sends a web service request and receives the response accordingly. In the context of the present invention, the individual web service requests are specifically available for a plurality of requests such as for searching persons, searching organizations, adding a person with name and identification details into the central hub 110 and adding and/or updating joining and exit dates of a person to the central hub 110. If the organization is identified as a non-existent organization, the information remains as a part of the response from the central hub 110 and informs the client about the non-existence. It is understood here that, if an organization is found unregistered then the essential information involving organization attributes is passed on to the client as part of the response for validation purpose. This scenario can be eliminated by allowing searching for an organization in the user interface as well as a call in the web service. It is understood however that the users, based on their privileges, are able to call the web services through the web application or the user interface. The web services are integrated along with individual calls within the partner organization for providing a seamless working environment between the organization and the central hub 110.

In the context of the present invention, the central hub 110 includes a web service layer that provides an Application Programming Interface (API) of the central hub 110 to be integrated with the partner organizations along with their internal systems. This enables a high level of automation. The client of this web service present in the partner organization would complement the service provided by the partner organization to provide a web service that is to be accessed by the central hub 110.

In the context of the present invention, the user interface is a part of the central hub 110 that is available over the internet to add, update and verify information of individuals. The user interface 140 has an ability to add organizations, users and grant permissions which will not be provided through the web service.

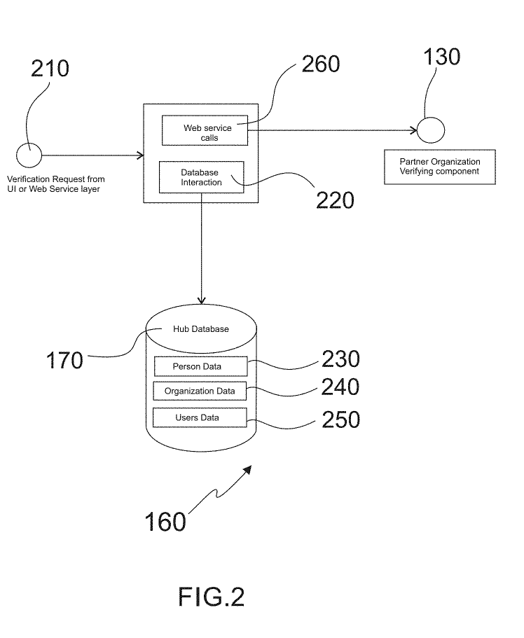

Referring to FIG. 2, a logical work flow of the core service component 160 and central hub 110 is illustrated. The service component 160 is configured to interact with all the components of the system 100 which a primary step that includes receiving verification request 210 from the users who login through the user interfaces 140 or a web service layer. In next step, the service component 160 makes database interaction calls 220 with the hub database 170 to add, update or verify information for individuals as well as organizations and users. It is understood however that the hub database 170 preferably stores information such as personal data 230, organization data 240 and user data 250 as illustrated. In step, the service component 160 also makes web service calls 260 with the partner organization verification component 130 for verification. The central hub 110 provides responses if the organization is unregistered or non-existing after being checked by the central hub 110. In next step, the central hub 110 collate the information from both the responses of database interaction calls 220 and the web service calls 260 and accordingly sends as a response to verification request 210 from user interfaces 140. Alternatively, the central hub 110 may send the response to verification request 210 from a web service call.

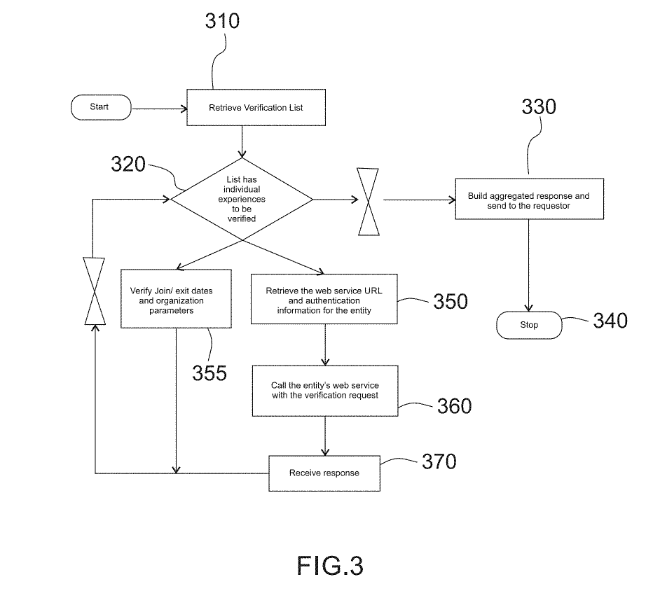

Referring to FIG. 3, an operational flowchart of the core service component 160 is shown wherein a verification list is retrieved in a first step 310 and verified in next step 320 to check if there is an individual experience to be verified as a part of the retrieved list. If it is observed that the list has no individual experience to be verified then the process moves to a step 330 wherein aggregated response is built and sent to the requestor to end the process at step 340. However, if it is observed that the list has individual experience that is to be verified then the process moves to a next step 350. For example, as shown in step 355, it is first verified if the joining/ exit date and organization parameters are matching with the already existing information in the central hub server upon receipt of the list of individual organization experiences and/or educational qualifications. It is understood here that deviation in said parameters is noted as a part of the response based on information obtained after making calls to hub database 170 to add, update or verify information for individuals as well as organizations and users. In step 350, a web service URL is and authentication information are retrieved.

In next step 360, a call is initiated with entity's web service with a verification request iteratively one after the other by using the web service URL provided by the partner organization by calling web service client. It is understood here that iterative call initiation is a process wherein collective result of steps 350, 355, 360 and 370 along with the aggregated result of the two separate tracks form one iteration cycle. It is understood here that the data needs to be verified or checked for each individual experience based on information received after making calls to the partner organizations for verification.

In next step 370, the results from responses from step 360 are provided as a response using web service calls 260 (Refer FIG. 2) made to the partner organizations and hub database calls 220 (Refer FIG. 2) at step 355. Accordingly, the response generated at step 370 is aggregated with a response from step 355 and thereafter it is conveyed as a part of response to step 330.

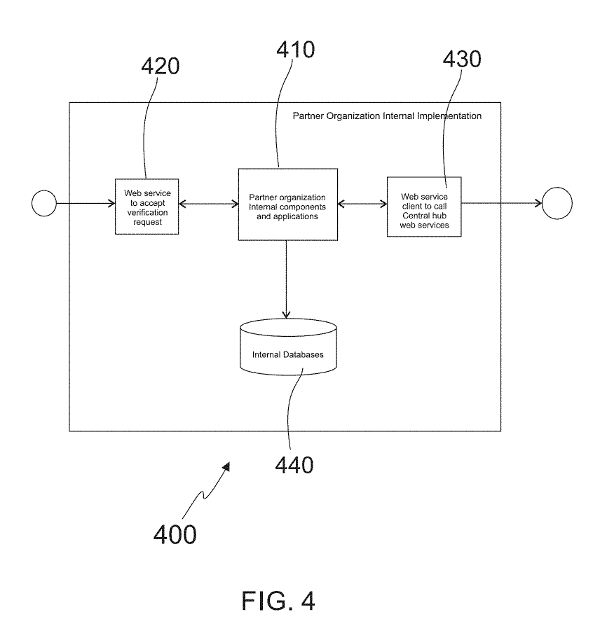

Referring to FIG. 4, partner organization architecture 400 of the web based background check system 100 is shown wherein the partner organization internal components and applications 410 are configured to be integrated with the central hub 110 through the APIs using a first web service 420 and a second web service 430. The first web service 420 is such that the partner organization provides a web service that verifies the details of an individual sent for verification by the central hub 110. The second web service 430 is such that the partner organization builds a web service client that is able to initiate a web service call to the central hub 110 for verifying complete credentials of an individual. The partner organization architecture 400 includes internal databases 440 that store all information of the partner organization internal components and applications 410.

It is understood here that the partner organizations are free to separately implement a user interface or integrate to an existing user interface as a part of internal applications thereof. Accordingly, it is understood here that user interface of the client is possibly different from user interface of the partner organization in accordance with the present invention. It is further understood here that the web service calls include calls to search an organization that is a partner organization of the central hub 110. The web service call also includes calls to search a person who is already part of the central hub database 170. The web service call also includes calls to raise a verification request. The web service call also includes calls to retrieve the common identifier between the central hub 110 and the partner organization to identify an individual across the network.

Referring to FIGS. 1-4, in operation, the web based background check system 100 advantageously provides complete automation for the verification of credentials of an individual with respect to any information that is electronically stored in collective nature. The web based background check system 100 advantageously provides results that are substantially quick provided that all the components of the system are up and running. The web based background check system 100 drastically reduces verification turnaround time. The web based background check system 100 advantageously provides offers to those candidates who are genuine in all considered aspects of verification. The web based background check system 100 advantageously increases efficiency of the human resource departments considering the amount of time spent in current manual verification process. In operation, the central hub 110 acts as a controller and an aggregator of information thereby forming an access point to interact with numerous other partner organizations. The web based background check system 100 advantageously facilitates sharing of any new data for verification across the system based on suggestions of partner organizations and can be easily spread across the network wherein the implemented suggestions are available across the network partner organizations for use. In the context of the present invention, the partner organizations provide a mechanism to decide if some minor factors in black listing some organizations can be considered or ignored.

In operation, user interaction with the system 100 is described hereinafter. It is understood here that the user is either an individual or an organization that raises a request with the system 100 for verification of education details such as a resume. The system 100 is configured such that the contents can be automatically pulled by the system 100 based on the internal design of the partner organization. Alternatively, the contents of the system 100 can be manually checked before raising a verification request. It is understood here that the amount of automation for raising a verification request and providing a response to the central hub 100 are decided by the partner organization.

In an initial step, the user raises a verification request to the central hub 110. In an initial step, the central hub 110 searches for the person to retrieve a unique ID and full name of person whose credentials are to be verified. In this one embodiment, the central hub 110 uniquely maintains individual information using government IDs such as Aadhar, PAN and the like. In this one embodiment, the central hub 110 provides a result with details such as full name and ID of the person.

In next step, the central hub 110 identifies an appropriate institution based on received parameters wherein at least four characters of the name of organization and the country of the organization are entered as an input. Accordingly, the central hub 110 makes a plurality of calls to receive organization ID, organization name and organization address as a response. It is understood here that the request raising organization is allowed to select the matching organization. If the organization is not a part of the network then the central hub 110 is accordingly informed so that the central hub 110 contacts the unregistered organization and request to be part of the network. In the context of the present invention, the central hub 110 provides a search mechanism to search the partner organizations wherein at least few characters of the organization name and the country are used in finding a list of organizations.

In next step, after getting required information of the person and organization, the central hub 110 raises a request for verification. The request includes experience details such as Joining date, Exit date, Employee ID, Registration ID and the like, that are passed on as an individual verification experience. The central hub 110 splits the request and calls the respective organizations using web services provided by the partner organizations in order to receive a response from the partner organizations. The response from each partner organization includes accuracy verification of joining and exit dates, verification result of employee ID with the name/unique ID provided by the central hub 110 and any other parameters across the network such as reasons for leaving the organization, comments from the prior employer, any deviations observed when request data is compared with data available with organization and the like. It is understood here that the central hub 110 includes an authentication service that is integrated with a user detail logic module of the central hub 110. Further, it is understood here that authentication is facilitated by a common encryption mechanism that is agreed between the central hub 110 and the partner organization.

In next step, the central hub 110 collates the response along with the date module response and organization verification module response for date check and organization validation respectively. It is understood here that the date module check, organization verification and partner organization check are done one after the other in a single iteration and accordingly all the results are stored in different variables as part of a single complete response. In final step, the single complete response is sent back to the user as part of the web service response.

It is not intended to be exhaustive or to limit the invention to the precise form disclosed. Many modifications and verifications are possible in light of the above teaching. It is intended that the scope of the invention be limited not by this detailed description, but rather by the claims appended hereto. It is also to be understood that the following claims are intended to cover all of the generic and specific features of the invention described herein.

I claim:

1) A web based background check system for access and verification of credentials comprising:
a partner organization verification request raising component configured to run on a computing device, the verification request raising component internally integrated with at least one partner organization to raise a profile information verification request;
a central hub configured with a controller component, a core service component, and a central hub database, the controller component configured to communicate with a user interface, the core service component configured to communicate with the partner organization verification request raising component through web service calls, the central hub configured to split an individual experience and process the same by checking for a plurality of discrepancies in said individual experience and organizational attributes and accept said web service calls, the central hub facilitating verification of the joining/exit date and organization parameters by matching with already existing information in a database connected to the server thereof;
a partner organization verification component integrated with a partner organization internal system, the partner organization verification component configured to receive said web service calls raised by the central hub, the partner organization verification component configured to selectively run on a server of the partner organization or a cloud based system, the verification component configured to validate individual experience verification request from the central hub;
an organization verification module configured to maintain attributes of an organization in response to the profile information verification request for validating legality and authenticity thereof; and
an authentication module configured to authenticate users who add/or update data and request verification.

2) The web based background check system as claimed in claim 1, wherein the partner organization verification component exposes web services to the central hub.

3) The web based background check system as claimed in claim 1, wherein the partner organization verification component is fully integrated with the partner organization system to avoid manual intervention therein.

4) The web based background check system as claimed in claim 1, wherein the partner organization verification request raising component and the partner organization verification component are configured on a single computing device of the partner organization.

5) The web based background check system as claimed in claim 1, wherein the partner organization verification request raising component and the partner organization verification component are configured on different computing devices of the partner organization.

6) The web based background check system as claimed in claim 1, wherein the partner organization verification request raising component and the partner organization verification component respectively have software that run on a single server of the partner organization.

7) The web based background check system as claimed in claim 1, wherein the partner organization verification request raising component and the partner organization verification component have software that run on different servers of the partner organization.

8) The web based background check system as claimed in claim 1, wherein the central hub includes a person module to add a person into the central hub, individually identify a person and provide a unique ID to the person.

9) The web based background check system as claimed in claim 1, wherein the central hub includes a date module to verify the dates in the profile information verification request against the unique ID of the individual for the partner organization.

10 ) The web based background check system as claimed in claim 1, wherein the core service component segregates the profile information verification request respectively to the date module, the organization verification module, and the partner organization verification component.

11) The web based background check system as claimed in claim 1, wherein the core service component aggregates the multiple responses coming from the date module, organization verification module and partner organization verification component and sends the same to the user interface and/or the web service.

12) A web based background check method for access and verification of credentials comprising the steps of:
a) initiating a profile information verification request by contacting a central hub through a computing device;
b) validating a plurality of credentials in the profile verification request thereby running validation of a plurality of partner organizations through the central hub;
c) collecting attributes related to the validation through the central hub;
d) splitting an individual experience and processing the same by checking for discrepancies in experience and organization attributes;
e) requesting a plurality of verification partner organizations for providing verification service to the central hub;
f) conducting a validation run through the verification partners for sending a plurality of responses by validating a verifying data with standard attributes being shared with the central hub;
g) verifying if the joining/exit date and organization parameters are matching with the already existing information in a database connected to a server of the central hub;
h) collating the responses from all the verification partner organizations along with a validation result of the validation run in the central hub; and
i) sending the validation result as a response to the profile information verification request.

13) The web based background check method as claimed in claim 12, wherein the request for profile information verification is sent to the central hub through a web service such that the central hub utilizes web services provided by the partner organizations.

14) The web based background check method as claimed in claim 12, wherein the partner organizations such as educational institutions, training institutions, central education boards, state educations boards, banks, software companies, pharmaceutical companies, construction companies, automobile industries, manufacturing, and governmental departments and the like.

15) The web based background check method as claimed in claim 12, wherein the partner organizations verify and validate credentials mentioned in the request for profile information upon request to the central hub from any other partner organizations.

16) The web based background check method as claimed in claim 12, wherein credentials mentioned in the request for profile information includes a deviation observed during verification as part of the collated response to the requesting partner organization.

17) The web based background check method as claimed in claim 12, wherein attributes of a partner organization include registration with government, tax compliance, physical existence and the like.

18) The web based background check method as claimed in claim 12, wherein the partner organization validates data provided in the web service request from the central hub using a computing device or software running on a server to automatically check the data in the associated storage system.

19) The web based background check method as claimed in claim 12, wherein the partner organizations send attributes and any deviations thereof to the central hub.

20) The web based background check method as claimed in claim 12, wherein the verification data includes duration of work, joining date, exit date, references of colleagues in the organization, employment profile, last employment duration, last employment position and the like.

21) The web based background check method as claimed in claim 12, wherein the central hub generates unique ID to communicate the verification data between the central hub and the partner organizations.
